(19) United States
(12) Patent Application Publication
(10) Pub. No.: US 2026/0140082 A1
(43) Pub. Date: May 21, 2026

(54) ELECTRODE

(71) Applicant: Murata Manufacturing Co., Ltd., Nagaokakyo-shi (JP)

(72) Inventors: Kosuke SUGIURA, Nagaokakyo-shi (JP); Brendan B. Murphy, Nagaokakyo-shi (JP)

(21) Appl. No.: 19/419,786

(22) Filed: Dec. 15, 2025

Related U.S. Application Data
(63) Continuation of application No. PCT/JP2024/021862, filed on Jun. 17, 2024.

(30) Foreign Application Priority Data
Jun. 20, 2023 (JP) 2023-101021
Dec. 11, 2023 (JP) 2023-208787

(51) Int. Cl. G01N 27/327

(52) U.S. Cl. CPC G01N 27/327

(57) ABSTRACT

An electrode that includes: a substrate; a silver/silver chloride electrode section on at least a part of a surface of the substrate; and a film containing particles of a two-dimensional material including one layer or a plurality of layers on at least a part of a surface of the silver/silver chloride electrode section exposed to an external environment, wherein the one layer or the plurality of layers include a layer body represented by: MₘXₙ, wherein M is one or more metals of Group 3, 4, 5, 6, and 7 and includes Ti, X is a carbon atom, a nitrogen atom, or a combination thereof, n is 1 to 4, and m is more than n but not more than 5; and a modifier or terminal T is present on a surface of the layer body.

### CROSS REFERENCE TO RELATED APPLICATIONS

The present application is a continuation of International application No. PCT/JP2024/021862, filed Jun. 17, 2024, which claims priority to Japanese Patent Application No. 2023-101021, filed Jun. 20, 2023, and Japanese Patent Application No. 2023-208787, filed Dec. 11, 2023, the entire contents of each of which are incorporated herein by reference.

### TECHNICAL FIELD

The present disclosure relates to an electrode.

### BACKGROUND ART

In recent years, MXene has been attracting attention as a new material having conductivity. MXene is a kind of so-called two-dimensional material, and more specifically, MXene is a two-dimensional material (a layered material) having a form of one layer or a plurality of layers as described later. In general, MXene is in the form of particles, which can include powders, flakes, nanosheets, and the like, of such a two-dimensional material (a layered material). Patent Document 1 discloses a bioelectrode formed of a contact material containing MXene.
Patent Document 1: WO 2019/055784 A

### SUMMARY OF THE DISCLOSURE

In Patent Document 1, MXene is used in a contact portion with a subject. However, Patent Document 1 does not particularly discuss an electrode including a silver/silver chloride electrode section, and it is considered that the impedance of the electrode including the silver/silver chloride electrode section is insufficiently reduced. An object of the present disclosure is to provide an electrode including a silver/silver chloride electrode section and exhibiting low impedance.

According to one gist of the present disclosure, there is provided an electrode comprising a substrate, a silver/silver chloride electrode section, and a film containing particles of a two-dimensional material including one layer or a plurality of layers, wherein
the one layer or the plurality of layers include:
a layer body represented by the following formula:

MₘXₙ,
wherein M is one or more metals of Group 3, 4, 5, 6, and 7 and includes Ti,
X is a carbon atom, a nitrogen atom, or a combination thereof,
n is not less than 1 and not more than 4, and
m is more than n but not more than 5; and
a modifier or terminal T existing on a surface of the layer body, wherein T is one or more selected from the group consisting of a hydroxy group, a fluorine atom, a chlorine atom, an oxygen atom, and a hydrogen atom.

According to the present disclosure, there is provided a novel electrode having a substrate, a silver/silver chloride electrode section, and a film containing particles of a prescribed two-dimensional material (herein also referred to as “MXene”), the electrode having low impedance.

### BRIEF DESCRIPTION OF THE DRAWINGS

FIGS. 1(a) and 1(b) are schematic cross-sectional views illustrating particles of a two-dimensional material (MXene) usable in one embodiment of the present disclosure, in which FIG. 1(a) illustrates single-layer MXene particles, and FIG. 1(b) illustrates multilayer (exemplarily, two-layer) MXene particles.

FIG. 2 is a schematic cross-sectional view illustrating one embodiment of the electrode of the present disclosure.

FIG. 3 is a schematic cross-sectional view illustrating another embodiment of the electrode of the present disclosure.

FIG. 4 is a schematic cross-sectional view illustrating another embodiment of the electrode of the present disclosure.

FIG. 5 is a schematic cross-sectional view illustrating another embodiment of the electrode of the present disclosure.

FIG. 6 is a schematic cross-sectional view illustrating another embodiment of the electrode of the present disclosure.

FIG. 7 is a measurement result of impedance in Examples.

FIG. 8 is a measurement result of another impedance in Examples.

### DETAILED DESCRIPTION OF THE PREFERRED EMBODIMENTS

Hereinafter, an electrode according to an embodiment of the present disclosure will be described in detail, but the present disclosure is not limited to such an embodiment.

### (Electrode)

The electrode according to the present embodiment includes a substrate, a silver/silver chloride electrode section, and a film containing particles of a two-dimensional material including one layer or a plurality of layers (hereinafter sometimes referred to as “MXene-containing film”). Thereby, an electrode including a silver/silver chloride electrode section and exhibiting low impedance can be provided.

Hereinafter, the film containing particles of a two-dimensional material including one layer or a plurality of layers, which film constitutes the electrode of the present embodiment, will be described. The two-dimensional material can be understood as a layered compound and is also represented by “MₘXₙTₛ”, wherein s is any number and traditionally x or z may be used instead of s. Typically, n can be 1, 2, 3, or 4, but is not limited thereto.

In the above formula of MXene, M may be only Ti, or may include Ti and further include one or more metals of Group 3, 4, 5, 6, and 7 other than Ti. For example, M may include Ti and further include one or more selected from the group consisting of Zr, Hf, V, Nb, Ta, Cr, Mo, and Mn. When M includes an element other than Ti, the element other than Ti is more preferably one or more selected from the group consisting of V, Cr, and Mo.

Known MXene's include those whose formula MₘXₙ given above is expressed as below.

Ti₂C, Ti₂N, (Ti, V)₂C, (Ti, Nb)₂C, Ti₃C₂, Ti₃N₂, Ti₃ (CN), (Ti, V)₃C₂, (Ti₂Nb)C₂, (Ti₂Ta)C₂, (Ti₂Mn)C₂, (V₂Ti)C₂, (Cr₂Ti)C₂, (Mo₂Ti)C₂, (W₂Ti)C₂, Ti₄N₃, (Ti, Nb)₄C₃, (Ti₂Nb₂)C₃, (Ti₂Ta₂)C₃, (V₂Ti₂)C₃, (Cr₂Ti₂)C₃, (Mo₂Ti₂)C₃, (W₂Ti₂)C₃

Typically, in the above formula, M can be titanium, or titanium and vanadium, and X can be a carbon atom or a nitrogen atom. For example, a MAX phase, which is a precursor of MXene, is Ti₃AlC₂, and MXene is Ti₃C₂Tₛ (in other words, M is Ti, X is C, n is 2, and m is 3).

It is noted, in the present embodiment, MXene may contain remaining A atoms derived from MAX, which is a precursor of MXene, at a relatively small amount, for example, at 10% by mass or less with respect to the original amount of A atoms. The amount of the remaining A atoms can be preferably 8% by mass or less, and more preferably 6% by mass or less. However, even if the amount of the remaining A atoms exceeds 10% by mass, there may be no problem depending on the application and conditions of use.

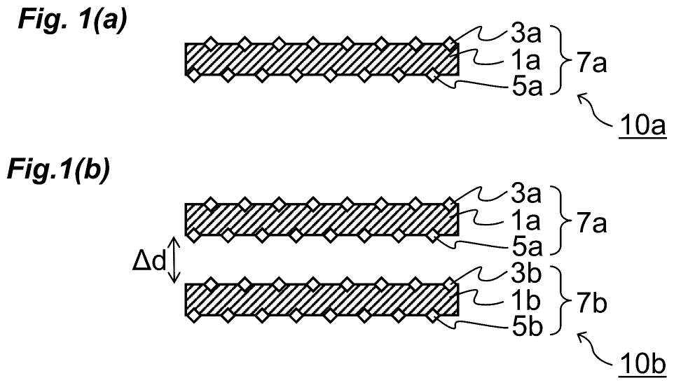

In the following, the MXene particles according to the present embodiment will be described with reference to FIG. 1.

The MXene particle according to the present embodiment is an aggregate including MXene 10a having one layer (single-layer MXene) whose example is schematically illustrated in FIG. 1(a), and more specifically, an aggregate including two or more MXene's 10a. More specifically, the MXene 10a is an MXene layer 7a having a layer body represented by MₘXₙ (MₘXₙ layer) la and modifiers or terminals T 3a, 5a existing on a surface of the layer body 1a (more specifically, on at least one of both surfaces facing opposite from each other, of each layer). Therefore, the MXene layer 7a is also represented by “MₘXₙTₛ”, wherein s is any number.

In the MXene particle according to the present embodiment, the MXene may be composed of one layer or a plurality of layers. Examples of the MXene composed of a plurality of layers (multilayer MXene) include, but are not limited to, a two-layered MXene 10b as schematically illustrated in FIG. 1(b). 1b, 3b, 5b, and 7b in FIG. 1(b) are the same as 1a, 3a, 5a, and 7a in FIG. 1(a) described above. Two adjacent MXene layers (e.g., 7a and 7b) in the multilayer MXene may not necessarily be completely separated from each other, but may be partially in contact with each other. The MXene 10a is one that exists as a single layer resulting from separation of the multilayer MXene 10b into segments, and may exist as a mixture of the single-layer MXene 10a and the multilayer MXene 10b with some multilayer MXene 10b remaining unseparated. Even when the multilayer MXene is included, the multilayer MXene is preferably an MXene having a small number of layers obtained through a delamination treatment. The “small number of layers” means, for example, that the number of stacked MXene layers is 10 or less. Hereinafter, the “multilayer MXene having a small number of layers” may be referred to as “few-layer MXene”. The thickness in the stacking direction of the few-layer MXene may be 15 nm or less, and may be 10 nm or less. The single-layer MXene and the few-layer MXene may be collectively referred to as “single-layer/few-layer MXene”.

Most of the MXene may be single-layer/few-layer MXene. When most of MXene is single-layer/few-layer MXene, the specific surface area of the MXene can be made larger than that of multilayer MXene. As a result, when a laminate is used, for example, for applications requiring conductivity, deterioration of conductivity over time can be suppressed. For example, the single-layer/few-layer MXene in which the number of the stacked layers of MXene is 10 or less and the thickness is 15 nm or less, preferably 10 nm or less may account for, for example, 80% by volume or more, 90% by volume or more, or 95% by volume or more in the whole MXene. In addition, the volume of the single-layer MXene may be larger than the volume of the few-layer MXene. Since the true density of these MXene's does not greatly vary depending on the existence form, it can be said that the mass of the single-layer MXene is larger than the mass of the few-layer MXene. When these relationships are satisfied, the specific surface area of MXene can be increased, and for example, when used for applications in which conductivity is required, deterioration of conductivity over time can be suppressed. For example, the film may be formed of only the single-layer MXene.

Although the thickness of each layer of MXene, which corresponds to the MXene layers 7a and 7b, does not limit the present embodiment, the thickness of each layer may be, for example, not less than 1 nm and not more than 30 μm, and may be, for example, not less than 1 nm and not more than 5 nm, or not less than 1 nm and not more than 3 nm, which can vary mainly depending on the number of M atom layers included in each layer. For individual laminates of the multilayer MXene that may be included, the inter-layer distance (or gap dimension, denoted as Δd in FIG. 1(b)) is, for example, not less than 0.8 nm and not more than 10 nm, particularly not less than 0.8 nm and not more than 5 nm, and more particularly about 1 nm, and the total number of layers may be not less than 2 and not more than 20,000.

The silver/silver chloride electrode section that can be included in the electrode according to the present embodiment is not particularly limited, and a silver/silver chloride electrode generally used in electrodes can be used.

The material constituting the substrate (also referred to as “electrode substrate”) included in the electrode according to the present embodiment is not particularly limited, and may be composed of any appropriate material. In addition, the shape of the substrate is not limited. The substrate may be, for example, a resin film, a metal foil, a printed wiring board, a mounted electronic component, a metal pin, a metal wiring, a metal wire, or the like. For example, a board formed of a metal material, resin, or the like suitable for a biosignal sensing electrode can be appropriately adopted. Examples of the metal material, resin, or the like include at least one material among metal materials specified by gold, silver, copper, platinum, nickel, titanium, tin, iron, zinc, magnesium, aluminum, tungsten, and molybdenum, and a conductive polymer.

Although the present embodiment is not bound by any theory, the reason why the electrode according to the present embodiment exhibits a lower impedance, for example, in a low frequency region is presumed as follows. First, silver/silver chloride undergoes a reversible reaction as shown in the following formula (1). Therefore, a silver/silver chloride electrode exhibits a constant impedance at a low frequency (0.1 Hz to 1 Hz), for example. In the low frequency region, since the state becomes close to a direct current state, overvoltage is applied. Since a reaction occurs when an overvoltage is applied, a constant resistance according to the reaction rate is exhibited.

$$AgCl + {e}^{-} ⇔ Ag + {Cl}^{-} \qquad ( 1 )$$

Meanwhile, MXene has a large capacitance and the impedance at 1 Hz to 1000 Hz is low. The reason why the capacitance of an MXene is large is that the MXene has a layer structure. For example, flaky MXene has a shape of about 3 m in the planar direction and about 2 nm in thickness. An MXene electrode formed using the MXene has a millefeuille-like multilayer structure in which MXene flakes overlap each other. In addition, MXene has a property of adsorbing a metal cation, and exhibits a further increase in capacitance. For example, when the MXene electrode is brought into contact with the skin, moisture such as sweat on the skin penetrates into the multilayer structure of the MXene electrode to a certain depth, and the penetrated portion functions as an electrode. Therefore, the effective electrode area for developing capacitance is larger than that of a flat silver/silver chloride electrode, and the impedance is lowered. However, since the MXene electrode does not exhibit a reversible reaction of silver/silver chloride as represented by the above formula (1), there is a problem that the impedance is somewhat high in a low frequency region of 0.1 Hz to 1 Hz.

Unlike the MXene electrode, the electrode of the present embodiment has a silver/silver chloride electrode section and an MXene-containing film. The silver/silver chloride electrode section and the MXene-containing film may be separate, or the MXene-containing film may also serve as the silver/silver chloride electrode section. Hereinafter, first, an aspect in which the silver/silver chloride electrode section and the MXene-containing film are separate will be described. One embodiment of the electrode of the present embodiment is, for example, an electrode in which a silver/silver chloride electrode section is disposed on at least a part of a surface of a substrate, and an MXene-containing film is disposed on at least a part of a surface of the silver/silver chloride electrode section exposed to the external environment. In this case, in a low frequency region of 0.1 Hz to 1 Hz, an electrolytic solution (electrolytic substance) such as moisture on the skin penetrates into the MXene-containing film and reaches the silver/silver chloride electrode section, and a reversible reaction as represented by the formula (1) occurs, so that the impedance is kept low. On the other hand, in the frequency region higher than 1 Hz, the above-described effect by the MXene-containing film is exhibited, and the impedance is kept low. Another embodiment of the electrode of the present embodiment is, for example, an electrode in which an MXene-containing film is disposed on at least a part of a surface of a substrate, and a silver/silver chloride electrode section is disposed on at least a part of a surface of the MXene-containing film exposed to the external environment. Even in this case, the impedance can be kept low in a wide frequency region including a low frequency region. As one of the reasons for this, it is considered that in a low frequency region of 0.1 Hz to 1 Hz, a reversible reaction as represented by the above formula (1) occurs, and the impedance is suppressed low. On the other hand, in the frequency region higher than 1 Hz, it is considered that an electrolytic solution (electrolytic substance) such as moisture on the skin penetrates from voids such as defects that may be present in the silver chloride portion of the silver/silver chloride electrode section and reaches the MXene-containing film, so that the above-described effect by the MXene-containing film is exhibited, and the impedance is kept low.

The specific form of the MXene-containing film in the electrode of the present embodiment is not limited. Examples of the MXene-containing film include films in a solid state and films in a flexible and soft state. When the MXene-containing film has a sheet-like form, the thickness of the MXene-containing film can be measured by, for example, measurement with a micrometer, or cross-sectional observation by a method with a scanning electron microscope (SEM), a microscope, a laser microscope, or the like.

In the electrode of the present embodiment, the thickness of the MXene-containing film is preferably not less than 1 nm and not more than 5 μm. Within the above range, the impedance can be further reduced. By setting the thickness of the MXene-containing film to 5 μm or less, it is possible to more effectively exhibit an operation such as penetration of the electrolytic solution into the MXene-containing film described above. The thickness of the MXene-containing film can be, for example, 1.0 μm or less, can be 0.8 μm or less, or can be 0.5 μm or less. On the other hand, to sufficiently exhibit the effect of conductivity by the MXene-containing film, the thickness of the MXene-containing film is preferably 1 nm or more. The thickness of the MXene-containing film is more preferably 10 nm or more.

The film containing the particles of the two-dimensional material (MXene-containing film) may contain a polymer. By containing the polymer, the adhesion strength with the electrode substrate or the like can be improved.

The polymer is preferably a water-soluble polymer. By containing the water-soluble polymer, the adhesion strength with the electrode substrate can be further improved. Examples of the water-soluble polymer include a water-soluble conductive polymer which is a thiophene polymer, an MPC polymer containing a monomer having a phosphorylcholine group as a main component, an acrylic polymer, polyurethane, polyethylene glycol, carboxymethyl cellulose (CMC), an alginic acid polymer, a polyether, polyvinyl alcohol, a water-soluble polyester, and a dicarboxylated polysaccharide. The water-soluble polymer is preferably one or more selected from the group consisting of poly(3,4-ethylenedioxythiophene)-poly(styrenesulfonic acid) (PEDOT:PSS), Lipidure (registered trademark) A, Lipidure (registered trademark) PMB, polyurethane, polyacrylic acid, sodium polyacrylate, and cationically modified PVA. By containing one or more of these water-soluble polymers, the adhesion strength with the electrode substrate can be further improved.

When the film containing the particles of the two-dimensional material contains a polymer, the proportion of the particles of the two-dimensional material is, for example, not less than 0.5% by mass and not more than 50% by mass. By setting the proportion of the particles of the two-dimensional material to 0.5% by mass or more, a signal can be detected with high sensitivity. The proportion of the particles of the two-dimensional material is more preferably 1.0% by mass or more. From the viewpoint of securing higher flexibility of a composite material, the proportion is preferably 50% by mass or less, and more preferably 40% by mass or less. The proportion of the particles of the two-dimensional material refers to the proportion in the film. The MXene-containing film may contain additives such as a colorant and an antioxidant, and in this case, the proportion of the particles of the two-dimensional material refers to the proportion (% by mass) in the film including the additives.

The electrode according to the present embodiment can be preferably used as, for example, a biosignal sensing electrode, and can be preferably used as, for example, an electrode or the like for measuring EEG (electroencephalogram), ECG (electrocardiogram), or the like, capable of detecting biological information such as an electrical signal from the brain or the heart with high sensitivity.

The used frequency region of the electrode according to the present embodiment is not particularly limited. The electrode according to the present embodiment can exhibit excellent conductivity (low impedance) particularly when used in a relatively low frequency region (1000 Hz or less) in the frequency region. The electrode according to the present embodiment can be used in a frequency region of, for example, 500 Hz or less, or 300 Hz or less, or 200 Hz or less, or 150 Hz or less. The frequency region may be, for example, 0.05 Hz or more, or for example, 0.1 Hz or more. In particular, the electrode may be used at a frequency region of 0.1 to 150 Hz. Examples of an aspect in which the electrode can be used in a relatively low frequency region include measurement of an electroencephalogram, an electrocardiogram, or the like, and particularly include measurement of an electroencephalogram. Therefore, the electrode according to the present embodiment can be preferably used for the aforementioned measurement of an electroencephalogram, an electrocardiogram, or the like.

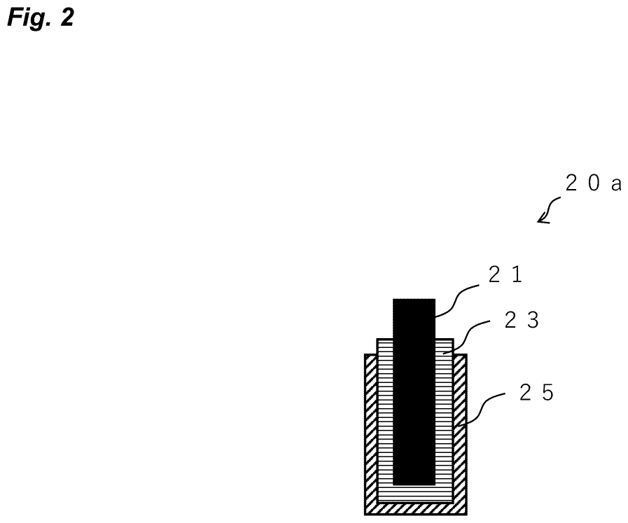

The electrode according to the present embodiment is merely required to have a substrate, a silver/silver chloride electrode section, and a MXene-containing film. One aspect of the electrode according to the present embodiment is an electrode in which a silver/silver chloride electrode section is disposed on at least a part of a surface of a substrate, and an MXene-containing film is disposed on at least a part of a surface of the silver/silver chloride electrode section exposed to the external environment. One example is an electrode 20a in which a silver/silver chloride electrode section 23 is disposed on a surface of an electrode substrate 21 and an MXene-containing film 25 is disposed on a surface of the silver/silver chloride electrode section 23 as illustrated in the schematic cross-sectional view in FIG. 2. As illustrated in FIG. 2, the electrode may be one in which the substrate has a tip portion and a longitudinal direction, the silver/silver chloride electrode section is disposed on surfaces of the tip portion and a side surface portion of the substrate, and the MXene-containing film is disposed on about 50% or more of a surface of the silver/silver chloride electrode section exposed to the external environment.

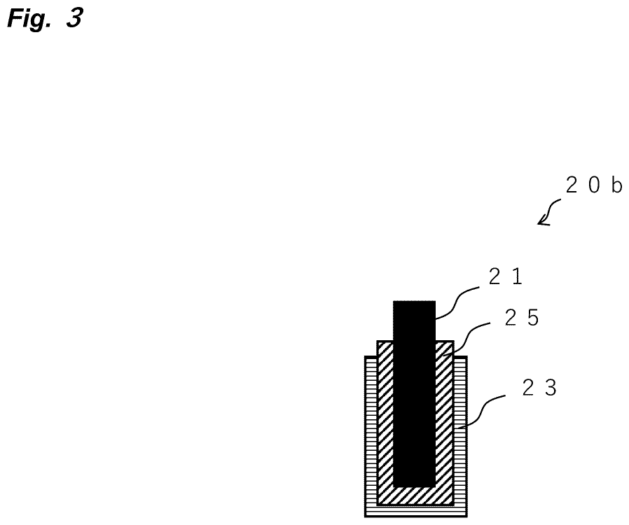

Another aspect of the electrode according to the present embodiment may be an electrode in which an MXene-containing film is disposed on at least a part of a surface of a substrate, and a silver/silver chloride electrode section is disposed on at least a part of a surface of the MXene-containing film exposed to the external environment. One example thereof may be an electrode 20b in which an MXene-containing film 25 is disposed on a surface of an electrode substrate 21, and a silver/silver chloride electrode section 23 is disposed on a surface of the MXene-containing film 25 as illustrated in a schematic cross-sectional view in FIG. 3, for example. As illustrated in FIG. 3, the electrode may be one in which the substrate has a tip portion and a longitudinal direction, the MXene-containing film is disposed on a surface including the tip portion of the substrate, and the silver/silver chloride electrode section is disposed on about 50% or more of a surface of the MXene-containing film exposed to the external environment.

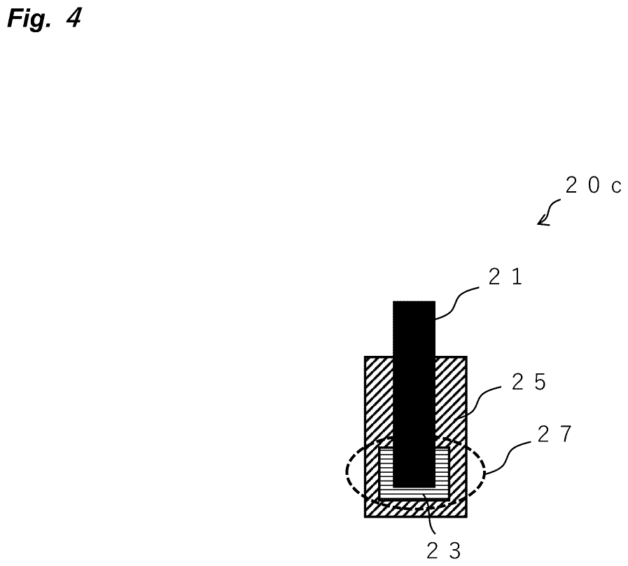

One modification example of FIG. 2 may be an electrode 20c in which the proportion of the silver/silver chloride electrode section 23 disposed on the surface of the electrode substrate 21 is smaller than that in FIG. 2 as illustrated in a schematic cross-sectional view of FIG. 4. As illustrated in FIG. 4, the electrode may be one in which the substrate has a tip portion and a longitudinal direction, the silver/silver chloride electrode section is disposed on a surface including the tip portion of the substrate, and the MXene-containing film (film containing particles of a two-dimensional material) is disposed on the entire surface of the silver/silver chloride electrode section exposed to the external environment. The electrode of the present embodiment may be in an aspect in which the substrate is, for example, a contact pin having a tip portion and a longitudinal direction, the silver/silver chloride electrode section 23 is formed only in a tip region 27 of the contact pin, and the MXene-containing film 25 is disposed to cover the entire surface of the silver/silver chloride electrode section 23 exposed to the external environment as illustrated in FIG. 4. In the case of this aspect, for example, when the electrode is used as a biosensing electrode, the surface in contact with the skin is an MXene-containing film, and thus the electrode is superior in biocompatibility. In addition, it is considered that by controlling the proportion of the silver/silver chloride electrode section in the electrode and covering the silver/silver chloride electrode section with the MXene-containing film as illustrated in FIG. 4, degradation of the silver/silver chloride electrode section is suppressed, and the life of the electrode can be extended.

In the electrode according to the present embodiment, as illustrated in FIG. 2 and the like, the silver/silver chloride electrode section and the MXene-containing film are preferably in direct contact at least partially.

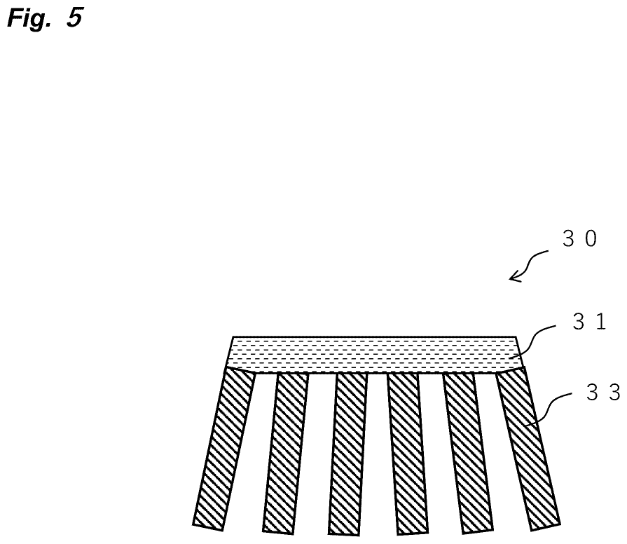

Another aspect of the electrode according to the present embodiment may be an electrode in a brush shape comprising a support and a plurality of contact pins for being brought into contact with an object to be measured, wherein at least one contact pin of the plurality of contact pins has a substrate, a silver/silver chloride electrode section, and a film containing particles of a two-dimensional material including one layer or a plurality of layers, and in a site including a tip of the contact pin, the silver/silver chloride electrode section is disposed on at least a part of a surface of the substrate, and the MXene-containing film is disposed on at least a part of a surface of the silver/silver chloride electrode section exposed to the external environment. For example, the electrode may be an electrode 30 in a brush shape in which a plurality of contact pins 33 are connected to a support 31 as illustrated in FIG. 5, and each of the plurality of contact pins 33 can take any one of the aspects of FIGS. 2 to 4 described above, for example.

Next, an aspect in which the MXene-containing film also serves as a silver/silver chloride electrode section will be described. In this aspect, the film containing the particles of the two-dimensional material (MXene particles) further contains silver/silver chloride, and is also a silver/silver chloride electrode section. The film may be a film in which silver/silver chloride and MXene are dispersed with each other (hereinafter sometimes referred to as “silver/silver chloride-MXene dispersion film”). By forming a silver/silver chloride-MXene dispersion film, the impedance can be reduced in a frequency range wider than the case of using silver/silver chloride alone. Silver has high conductivity, whereas silver/silver chloride has no conductivity. The conductivity of MXene is one to two orders of magnitude lower than silver, but the impedance is lower than silver/silver chloride. Therefore, as the reason why the impedance of the dispersion of MXene and silver/silver chloride is lower than that of MXene alone and silver/silver chloride alone, it is considered that low conductivity of MXene is improved by silver contained in silver/silver chloride. This effect is obtained by dispersing silver/silver chloride and MXene. To further reduce the impedance, the volume ratio of MXene in the dispersion film is preferably 25% by volume or more, more preferably not less than 30% by volume and not more than 75% by volume, and more preferably 70% by volume or less.

Examples of the third component other than silver/silver chloride and MXene in the silver/silver chloride-MXene dispersion film include a binder that can be contained in a silver/silver chloride paste that can be used in the production of the silver/silver chloride-MXene dispersion film, organic dispersion medium molecules, and inorganic materials as thickeners. The volume ratio of the third component in the silver/silver chloride-MXene dispersion film may be, for example, 5% by volume or less, or 1% by volume or less.

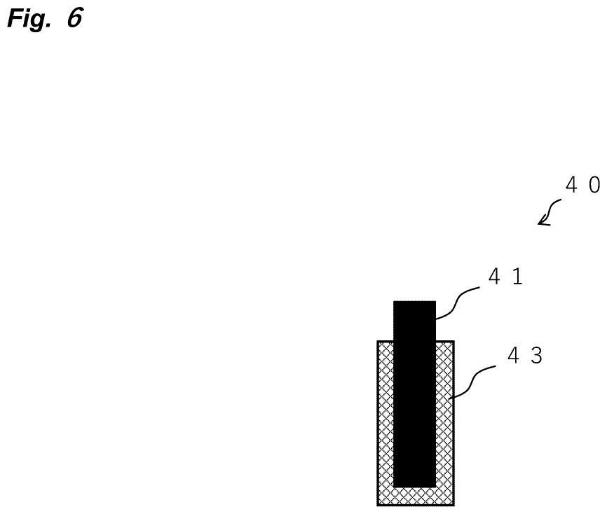

One aspect of the electrode including the silver/silver chloride-MXene dispersion film is, for example, an electrode 40 in which a silver/silver chloride-MXene dispersion film 43 is disposed on a surface of an electrode substrate 41 as illustrated in a schematic cross-sectional view in FIG. 6.

Another aspect of the electrode according to the present embodiment may be an electrode in a brush shape comprising a support and a plurality of contact pins for being brought into contact with an object to be measured, wherein at least one contact pin of the plurality of contact pins has a substrate and the silver/silver chloride-MXene dispersion film, and in a site including a tip of the contact pin, the silver/silver chloride-MXene dispersion film is disposed on at least a part of a surface of the substrate. For example, the electrode may be an electrode 30 in a brush shape in which a plurality of contact pins 33 are connected to a support 31 as illustrated in FIG. 5, and each of the plurality of contact pins 33 can take the aspect of FIG. 6 described above, for example.

FIGS. 2 to 6 are explanatory diagrams for easy understanding, and shapes, sizes such as film thicknesses, and the like of the electrode substrate, the silver/silver chloride electrode section, the MXene-containing film, the silver/silver chloride-MXene dispersion film, and the like, the ratio of the sizes, the number of contact pins, the interval, the arrangement, and the like in these diagrams may be different from those of actual electrodes. In addition, the electrode according to the present embodiment has been described with reference to the drawings, but the electrode according to the present embodiment is not limited to the aspect illustrated in the drawings. For example, the cross section of the contact pin of the brush-shaped electrode may be not only the rectangular shape illustrated in the above drawings but also a tapered triangular shape, a tapered trapezoidal shape, or the like. In addition, the tip of the contact pin may be a flat surface, a convex curved surface, or the like.

### (Method of Manufacturing Electrode)

The electrode according to the present embodiment can be manufactured, for example, by a method described below. However, the method for manufacturing the electrode according to the present embodiment is not limited to this embodiment.

First, a method for manufacturing an electrode in which a silver/silver chloride electrode section and an MXene-containing film are separately formed will be described.

One example of a method for manufacturing the electrode according to the present embodiment may include:
(a) preparing particles of a two-dimensional material including one layer or a plurality of layers, wherein
the one layer or the plurality of layers each include a layer body represented by the following formula:

MₘXₙ
wherein M is one or more metals of Group 3, 4, 5, 6, and 7 and includes Ti,
X is a carbon atom, a nitrogen atom, or a combination thereof,
n is not less than 1 and not more than 4, and
m is more than n but not more than 5; and
a modifier or terminal T existing on a surface of the layer body, wherein T is one or more selected from the group consisting of a hydroxy group, a fluorine atom, a chlorine atom, an oxygen atom, and a hydrogen atom; and
(b1) forming a film containing the particles of the two-dimensional material using the particles of the two-dimensional material on at least a part of a surface of the silver/silver chloride electrode section (a surface exposed to the external environment) formed on a surface of the substrate; or
(b2) forming a film containing particles of a two-dimensional material on at least a part of the substrate using the particles of the two-dimensional material and subsequently forming a silver/silver chloride electrode section on at least a part of a surface of the film containing particles of a two-dimensional material (surface exposed to the external environment). In the following, the respective steps will be described.

### Step (a)

First, a prescribed precursor is prepared. The prescribed precursor that can be used in the present embodiment is a MAX phase, which is a precursor to MXene, and
is represented by the following formula:

MₘAXₙ
wherein M is one or more metals of Group 3, 4, 5, 6, and 7 and includes Ti,
X is a carbon atom, a nitrogen atom, or a combination thereof,
A is one or more elements of Group 12, 13, 14, 15, and 16,
n is not less than 1 and not more than 4, and
m is more than n but not more than 5.

Said M, said X, said n, and said m are as described for MXene. A is one or more elements of Group 12, 13, 14, 15, and 16, and is usually a Group A element, typically a Group IIIA element or a Group IVA element, and more specifically may comprise one or more elements selected from the group consisting of Al, Ga, In, Tl, Si, Ge, Sn, Pb, P, As, S, and Cd, and is preferably Al.

The MAX phase has a crystal structure in which a layer constituted of A atoms is located between two layers each represented by MₘXₙ (each layer can have a crystal lattice in which each X is located in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms.

The MAX phase can be produced by a known method. For example, a TiC powder, a Ti powder, and an Al powder are mixed in a ball mill, and the resulting mixed powder is calcined under an Ar atmosphere to afford a calcined body (block-shaped MAX phase). Thereafter, the calcined body obtained is pulverized with an end mill to afford a powdered MAX phase for the next step.

The surface of the MₘXₙ layer exposed through the removal of the A atom layer (and, in some cases, also a part of M atoms) as a result of selective etching (removal and, in some cases, also layer separation) of A atoms (and, in some cases, also a part of M atoms) from the MAX phase is modified by hydroxy groups, fluorine atoms, chlorine atoms, oxygen atoms, hydrogen atoms, etc., existing in an etching liquid (usually, an aqueous solution of a fluorine-containing acid is used, but the etching liquid is not limited thereto), so that the surface is terminated.

The etching can be conducted using an etching liquid containing F⁻, and a method using, for example, a mixed liquid of lithium fluoride and hydrochloric acid, a method using hydrofluoric acid, or the like may be used. The etching liquid contains a metal compound containing a monovalent metal ion, and an intercalation treatment of the monovalent metal ion may be performed simultaneously with the etching. Examples of the metal compound containing a monovalent metal ion include those to be used in the intercalation treatment described below. The content of the metal compound containing a monovalent metal ion in the etching liquid is preferably set to 0.001% by mass or more. The content is more preferably 0.01% by mass or more, and still more preferably 0.1% by mass or more. On the other hand, from the viewpoint of dispersibility in a solution, the content of the metal compound containing a monovalent metal ion in the etching liquid is preferably set to 10% by mass or less, and more preferably is 1% by mass or less.

After the etching, the layer separation of MXene (delamination, that is, separating multilayer MXene into single-layer MXene's) may be appropriately promoted by any suitable post-treatment (e.g., ultrasonic treatment, handshake, automatic shaker, or the like). Since the shear force of an ultrasonic treatment is excessively large so that the MXene can be destroyed, it is desirable to apply an appropriate shear force by handshake, an automatic shaker or the like, when it is desired to obtain a two-dimensional MXene (preferably single-layer MXene) having a larger aspect ratio.

For the layer separation of MXene, an intercalation treatment and delamination described below may be performed.

### (Intercalation Treatment)

For example, an intercalation treatment of monovalent metal ions including a step of mixing the etching product obtained by the etching treatment with a metal compound containing a monovalent metal ion may be performed. Examples of the monovalent metal ion constituting the metal compound containing a monovalent metal ion include alkali metal ions such as a lithium ion, a sodium ion, and a potassium ion, a copper ion, a silver ion, and a gold ion. Examples of the metal compound containing a monovalent metal ion include ionic compounds in which the metal cation is bonded to a cation. Examples thereof include an iodide, a phosphate, a sulfide salt including a sulfate, a nitrate, an acetate, and a carboxylate of the metal ion. A lithium ion is preferable as the monovalent metal ion, and metal compounds containing a lithium ion are preferable as the metal compound containing a monovalent metal ion, ionic compounds of a lithium ion are more preferable, and one or more among an iodide, a phosphate, and a sulfide salt of a lithium ion are still more preferable. The use of a lithium ion as a metal ion is considered to assist the formation of a monolayer due to the fact that water hydrated to the lithium ion has the most negative dielectric constant.

The content of the metal compound containing a monovalent metal ion accounting for in the formulation for the intercalation treatment of a monovalent metal ion is preferably 0.001% by mass or more. The content is more preferably 0.01% by mass or more, and still more preferably 0.1% by mass or more. On the other hand, from the viewpoint of dispersibility in the solution, the content of the metal compound containing a monovalent metal ion is preferably set to 10% by mass or less, and more preferably is 1% by mass or less.

### (Delamination)

Delamination may be performed using an intercalation product obtained by intercalation. For example, delamination includes a step of centrifuging the intercalation product, discarding the supernatant liquid, and then washing the remaining precipitate with a dispersion medium such as water. Conditions for the delamination treatment are not particularly limited. The dispersion medium to be used for delamination is not particularly limited, and the delamination may be performed using one or more of a polar organic dispersion medium and an aqueous dispersion medium. A process of adding one or more of the polar organic dispersion medium and the aqueous dispersion medium, stirring the mixture, centrifuging the mixture, and collecting the supernatant liquid is repeated once or more, preferably twice or more and 10 times or less, whereby a supernatant liquid containing a single-layer/few-layer MXene may be obtained as a delamination product. Alternatively, by centrifuging the supernatant liquid, followed by discarding the supernatant liquid resulting from the centrifugation, a clay containing a single-layer/few-layer MXene may be obtained as a delamination product.

### Steps (b1, b2)

(b1) Using the particles of the two-dimensional material, a film containing the particles of the two-dimensional material is formed on at least a part of a surface of the silver/silver chloride electrode section (a surface exposed to the external environment) formed on a surface of the substrate; or

(b2) a film containing particles of a two-dimensional material is formed on at least a part of the substrate using the particles of the two-dimensional material, and subsequently a silver/silver chloride electrode section is formed on at least a part of a surface of the film containing particles of a two-dimensional material (surface exposed to the external environment).

In both the step (b1) and the step (b2), the same method as the usual method for forming a silver/silver chloride electrode can be adopted for the formation of the silver/silver chloride electrode section. In the following, a method of forming a film containing particles of a two-dimensional material (MXene-containing film) using the particles of the two-dimensional material on at least a part of a surface of the silver/silver chloride electrode section formed on a surface of a substrate (step (b1)) or at least a part of a surface of a substrate (step (b2)) will be described.

For the formation of the MXene-containing film, a dispersion of particles of a two-dimensional material (MXene particles), such as an MXene slurry prepared by diluting the single-layer/few-layer MXene-containing clay with a medium liquid can be used. The dispersion may be a suspension. The method for forming the MXene-containing film using the dispersion of MXene particles is not particularly limited. The dispersion of MXene particles may be fed, as received or after being appropriately conditioned (for example, dilution with a medium liquid, or addition of a binder), to at least a part of a surface of a silver/silver chloride electrode section in the case of the step (b1), or to at least a part of a surface of a substrate in the case of the step (b2). One example of a feeding method is application. Examples of the application method include a method of performing spray application using a nozzle such as a one-fluid nozzle, a two-fluid nozzle, or an air brush (a method using a spray coater), slit coating using a table coater, a comma coater, or a bar coater, screen printing, metal mask printing, spin coating, dip coating, and dropping. Examples of the medium liquid include an aqueous medium liquid and an organic medium liquid. The medium liquid that constitutes the dispersion of MXene particles is typically water, and in some cases, other liquid substances may be contained in a relatively small amount (e.g., 30% by mass or less, preferably 20% by mass or less based on the whole mass) in addition to water. Examples of the organic medium liquid include N-methylpyrrolidone, N-methylformamide, N,N-dimethylformamide, ethanol, methanol, dimethyl sulfoxide, ethylene glycol, and acetic acid.

When the MXene-containing film is formed of a composite material containing a polymer, the layered material and the polymer may be mixed together as illustrated below.

Examples thereof include mixing an aqueous MXene dispersion in which the MXene particles (particles of a two-dimensional material) are present in a dispersion medium, a dispersion of MXene and an organic dispersion medium, or an MXene powder with a polymer. The dispersion medium of the aqueous MXene dispersion is typically water, and may optionally contain other liquid substances in a relatively small amount (for example, 30% by mass or less, preferably 20% by mass or less based on the whole mass) in addition to water.

The stirring of the MXene particles and the polymer can be conducted using a dispersing device such as a homogenizer, a propeller stirrer, a thin-film spin type stirrer, a planetary mixer, a mechanical shaker, or a vortex mixer.

In the case of the step (b1), a slurry being a mixture of the MXene particles and the polymer is applied to at least a part of a surface (surface exposed to the external environment) of the silver/silver chloride electrode section formed on a surface of the substrate (for example, a board). In the case of the step (b2), the slurry may be applied to at least a part of the surface of a substrate (for example, a board). The application method is not limited, and examples thereof include a method of performing spray application using a nozzle such as a one-fluid nozzle, a two-fluid nozzle, or an air brush; slit coating using a table coater, a comma coater, or a bar coater; such methods as screen printing and metal mask printing; application methods by spin coating, dipping, or dropping.

Regardless of the presence or absence of the polymer, the formation and drying of the MXene-containing film can be appropriately repeated until a desired MXene-containing film thickness is obtained. For example, a combination of spraying and drying may be repeated multiple times. In the MXene-containing film, a liquid component derived from the liquid medium of the slurry may remain, or substantially no such liquid component may exist.

Drying may be performed under mild conditions such as natural drying (typically, the item to be dried is placed in an air atmosphere at normal temperature and normal pressure) or air drying (blowing air), or may be performed under relatively active conditions such as hot air drying (blowing heated air), heat drying, and/or vacuum drying. In the present embodiment, “drying” means removing a medium liquid that can be present in a precursor film obtained by the application. The drying may be performed, for example, at a temperature of 400° C. or less using a normal pressure oven or a vacuum oven. For example, the drying may be performed in the ranges of not less than 30° C. and not more than 200° C. and not less than 30 minutes and not more than 24 hours.

Next, an aspect in which the MXene-containing film also serves as a silver/silver chloride electrode section, that is, a method for manufacturing an electrode having a silver/silver chloride-MXene dispersion film will be described. MXene particles (particles of a two-dimensional material) can be produced by the method described above. An aqueous MXene dispersion in which the obtained MXene particles (particles of a two-dimensional material) are present in a dispersion medium, a dispersion of MXene and an organic dispersion medium, or an MXene powder may be mixed with silver/silver chloride. The dispersion medium of the aqueous MXene dispersion is typically water, and may optionally contain other liquid substances in a relatively small amount (for example, 30% by mass or less, preferably 20% by mass or less based on the whole mass) in addition to water. The silver/silver chloride may be, for example, a paste.

The stirring of the MXene particles and the silver/silver chloride can be conducted using a dispersing device such as a homogenizer, a propeller stirrer, a thin-film spin type stirrer, a planetary mixer, a mechanical shaker, or a vortex mixer.

The slurry, which is the mixture of the MXene particles and the silver/silver chloride, may be applied to at least a part of a surface of a substrate (for example, a board). The application method is not limited, and examples thereof include a method of performing spray application using a nozzle such as a one-fluid nozzle, a two-fluid nozzle, or an air brush; slit coating using a table coater, a comma coater, or a bar coater; such methods as screen printing and metal mask printing; application methods by spin coating, dipping, or dropping.

The formation and drying of the silver/silver chloride-MXene dispersion film can be appropriately repeated until a desired silver/silver chloride-MXene dispersion film thickness is obtained. For example, a combination of spraying and drying may be repeated multiple times. In the silver/silver chloride-MXene dispersion film, a liquid component derived from the liquid medium of the slurry may remain, or substantially no such liquid component may exist.

Drying may be performed under mild conditions such as natural drying (typically, the item to be dried is placed in an air atmosphere at normal temperature and normal pressure) or air drying (blowing air), or may be performed under relatively active conditions such as hot air drying (blowing heated air), heat drying, and/or vacuum drying. In the present embodiment, “drying” means removing a medium liquid that can be present in a precursor film obtained by the application. The drying may be performed, for example, at a temperature of 400° C. or less using a normal pressure oven or a vacuum oven. For example, the drying may be performed in the ranges of not less than 30° C. and not more than 200° C. and not less than 30 minutes and not more than 24 hours.

Although the electrode of the present disclosure and the method for the manufacture thereof have been described in detail above, the present disclosure allows various modifications. It should be noted that the electrode of the present disclosure may be manufactured by a method different from the manufacturing methods in the embodiments described above.

### EXAMPLES

In the following, the present disclosure will be described more specifically with reference to Examples. The present disclosure is not limited by the following Examples, and can be implemented with appropriate modifications as long as the modifications can be consistent with the above-described and later-described gist, and all of them are included in the technical scope of the present disclosure.

### Example 1

### 1. Preparation of Particles of Two-Dimensional Material

(1) Preparation of a precursor (MAX), (2) etching of the precursor, (3) washing after the etching, (4) Li intercalation, and (5) delamination each described in detail below were performed in order, affording particles of a two-dimensional material (MXene particles) first.

### (1) Preparation of Precursor (MAX)

A TiC powder, a Ti powder, and an Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The calcined body (block-shaped MAX) thus obtained was pulverized with an end mill to a maximum size of 40 m or less. Thereby, Ti₃AlC₂ particles were obtained as a precursor (powdered MAX).

### (2) Etching of Precursor (MAX)

Using the Ti₃AlC₂ particles (powder) prepared by the above method, etching was performed under the following etching conditions, affording a solid-liquid mixture (slurry) containing a solid component derived from the Ti₃AlC₂ powder.

### (Etching Conditions)

Precursor: Ti₃AlC₂ (sieved with a mesh size of 45 m)
Etching liquid composition: 49% HF 6 mL,
   H₂O 18 mL
   HCl (12M) 36 mL
Amount of precursor input: 3.0 g
Etching container: 100 mL Aiboy
Etching temperature: 35° C.
Etching time: 24 h
Stirrer rotation speed: 400 rpm
   (3) Washing after Etching

The slurry was equally divided into two portions and inserted into two 50 mL centrifuge tubes. Thereafter, the slurry was centrifuged at 3500 G for 5 minutes using a centrifuge, and then the supernatant liquid was discarded. Thereafter, (i) 35 mL of pure water was added to the remaining precipitate in each centrifuge tube, (ii) stirring was performed by handshake, (iii) centrifugation was performed at 3500 G for 5 minutes, and (iv) the supernatant liquid was removed. The steps (i) to (iv) were repeated 10 times. Finally, centrifugation was performed at 3500 G for 5 minutes to obtain a Ti₃C₂Tₛ-water medium clay.

### (4) Li Intercalation

The Ti₃C₂Tₛ-water medium clay prepared by the above method was stirred at not less than 20° C. and not more than 25° C. for 12 hours using LiCl as a Li-containing compound in accordance with the following conditions of Li intercalation, whereby Li intercalation was performed. The detailed conditions of the Li intercalation are as follows.

### (Conditions of Li Intercalation)

Ti₃C₂Tₛ-water medium clay (MXene after washing): Solid content: 0.75 g
LiCl: 0.75 g
Intercalation container: 100 mL Aiboy
Temperature: not less than 20° C. and not more than 25° C. (room temperature)
Time: 12 h
Stirrer rotation speed: 800 rpm
   (5) Delamination and Washing with Water

The slurry obtained by Li intercalation was charged into a 50 mL centrifuge tube, centrifuged under the condition of 3500 G using a centrifuge, and then the supernatant liquid was discarded. Next, (i) 40 mL of pure water was added to the remaining precipitate, and the mixture was stirred for 15 minutes with a shaker, then (ii) centrifuged at 3500 G, and (iii) the supernatant liquid was collected as a single-layer/few-layer MXene-containing liquid. The operations (i) to (iii) were repeated 4 times in total, affording a single-layer/few-layer MXene-containing supernatant liquid. Further, this supernatant liquid was centrifuged under the conditions of 4300 G and 2 hours using a centrifuge, and then the supernatant liquid was discarded, affording a single-layer/few-layer MXene-containing MXene clay as a remaining precipitate.

### 2. Preparation of Slurry of MXene/Polymer Composite Material (Example 1 and Comparative Example 2)

10.9 g of the MXene clay obtained in the above 1 and 3.1 g of Lipidure (registered trademark) A were weighed into a 50 mL centrifuge tube, and pure water was added such that the concentration of MXene in the mixture was 1.5% by mass. Thereafter, the mixture was stirred with a shaker for 15 minutes, affording a slurry of a MXene/polymer composite material as a liquid composition.

### 3. Preparation of Electrode (Example 1, Comparative Example 1, and Comparative Example 2)

In Example 1, an arbitrary amount of the slurry of the MXene/polymer composite material obtained in the above 2 was taken into a petri dish, and using this slurry, a tip part of a brush electrode, which is a simple electrode of silver/silver chloride (Soft Pulse) manufactured by Datwyler, was dip-coated. Thereafter, the formed MXene-containing film was dried using a normal pressure oven. The thickness of the obtained MXene-containing film (MXene/polymer composite material film) was about 1 μm.

As Comparative Example 1, a simple electrode of silver/silver chloride (brush electrode), which was not covered with the MXene-containing film (MXene/polymer composite material film), was prepared. Further, as Comparative Example 2, a substrate electrode in which a silver/silver chloride electrode section at the tip part of a silver/silver chloride simple electrode (brush electrode) was not formed was prepared, and then an MXene-containing film simple electrode in which an MXene-containing film (MXene/polymer composite material film) was formed on the surface of the substrate electrode was prepared.

### 4. Evaluation of Sample (Measurement of Impedance)

The impedance was measured as follows.

(a) On a biosheet (product number: HXBNXTB858510MX) manufactured by WetLab, a gel electrode (product number: 019-415200) manufactured by Natus was installed as a counter electrode and a reference electrode. In addition, the electrodes of Example 1, Comparative Example 1, and Comparative Example 2 prepared in the above 3 were installed as working electrodes.

(b) The impedance measurement was performed using an electrochemical measuring instrument (product number: PGSTAT302N) manufactured by Metrohm. Detailed measurement conditions are as follows.

### (Impedance Measurement Conditions)

Frequency region: 0.1 to 105 Hz
Number of plots: 61
Voltage: 10 mVrms

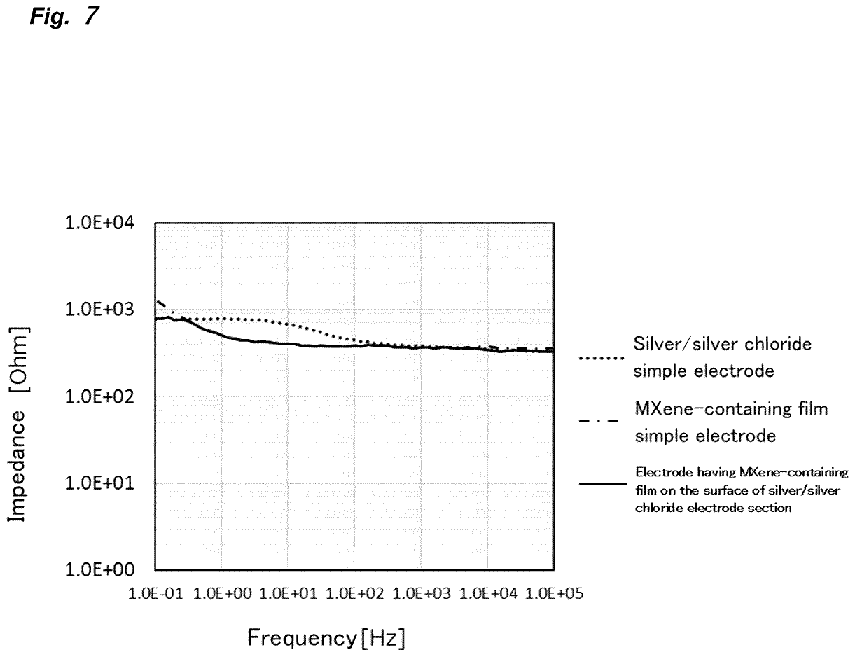

Measurement results of the impedance are illustrated in FIG. 7. As can be seen from FIG. 7, by providing an MXene-containing film on the surface of a silver/silver chloride electrode section as in the electrode of the present embodiment, the impedance was lower than that of the silver/silver chloride simple electrode (Comparative Example 1) in the region of about 0.3 to about 200 Hz. In the region of about 0.1 Hz to about 0.3 Hz, the impedance was lower than that of the MXene-containing film simple electrode (Comparative Example 2). From these facts, while the silver/silver chloride simple electrode (Comparative Example 1) and the MXene-containing film simple electrode (Comparative Example 2) had high impedance in some frequency regions, according to the electrode of the present embodiment, the impedance was equivalent to or lower than those of the silver/silver chloride simple electrode (Comparative Example 1) and the MXene-containing film simple electrode (Comparative Example 2) at any frequency, and stably exhibited low impedance in a relatively low frequency region. The reason for this is considered to be that by forming a prescribed MXene-containing film and a silver/silver chloride electrode section together on a surface of an electrode substrate, as described above, the effect of reducing impedance by both the MXene-containing film and the silver/silver chloride electrode section was exhibited.

### Examples 2 to 4 and Comparative Examples 3 to 6

### 1. Preparation of Particles of Two-Dimensional Material

Particles of a two-dimensional material were prepared in the same manner as in Example 1.

### 2. Preparation of Slurry of Composite Material of MXene and Silver/Silver Chloride

Prescribed amounts of the delamination product (aqueous slurry of MXene) obtained in the above 1, and a silver/silver chloride paste (Dupont 5880) manufactured by Dupont were taken into a 50 mL centrifuge tube, and pure water was added thereto such that the concentration of MXene was 1.5 wt %. Thereafter, the mixture was stirred with a shaker for 15 minutes, affording a slurry of a composite material of MXene and silver/silver chloride. Slurries having a volume ratio of MXene of 21% by volume (Comparative Example 3), 30% by volume (Example 2), 50% by volume (Example 3), 70% by volume (Example 4), and 79% by volume (Comparative Example 4) (the volume ratio of each remainder was the volume ratio of silver/silver chloride) were prepared.

### 3. Preparation of Electrode (Examples 2 to 4 and Comparative Examples 3 to 6)

Each of the slurries obtained in the above 2. was applied onto a polyimide film having a thickness of 75 m with a bar coater set at a gap of 250 m, affording molded bodies. Then, the molded bodies were dried at 80° C. for 2 hours using a normal pressure oven, affording electrodes on which silver/silver chloride-MXene dispersion films of Examples 2 to 4 and Comparative Examples 3 and 4 were formed.

As Comparative Example 5, a silver/silver chloride simple electrode using a simple substance of silver/silver chloride (Dupont5880 alone) in place of the silver/silver chloride-MXene dispersion film was prepared. As Comparative Example 6, an MXene film simple electrode using an MXene film in place of the silver/silver chloride-MXene dispersion film was prepared.

### 4. Evaluation of Sample (Measurement of Impedance)

The impedance was measured as follows.

(a) On a biosheet (product number: HXBNXTB858510MX) manufactured by WetLab, a gel electrode (product number: 019-415200) manufactured by Natus was installed as a counter electrode and a reference electrode. In addition, the respective electrodes of Examples 2 to 4 and Comparative Examples 3 to 6 prepared in the above 3 were installed as working electrodes. A Kapton tape punched out to a diameter φ of 3 mm was stuck to form a measurement electrode having an opening with a diameter φ of 3 mm.

(b) The impedance measurement was performed using an electrochemical measuring instrument (product number: PGSTAT302N) manufactured by Metrohm. Detailed measurement conditions are as follows. Then, a case where the impedance at 10 Hz was less than 1 kOhm was evaluated as ◯ (passed), and a case where the impedance at 10 Hz was 1 kOhm or more was evaluated as x (failed). As a result, Comparative Examples 3 to 6 were evaluated as x (failed), and Examples 2 to 4 were evaluated as ◯ (passed).

### (Impedance Measurement Conditions)

Frequency region: 0.1 to 104 Hz
Number of plots: 51
Voltage: 10 mVrms

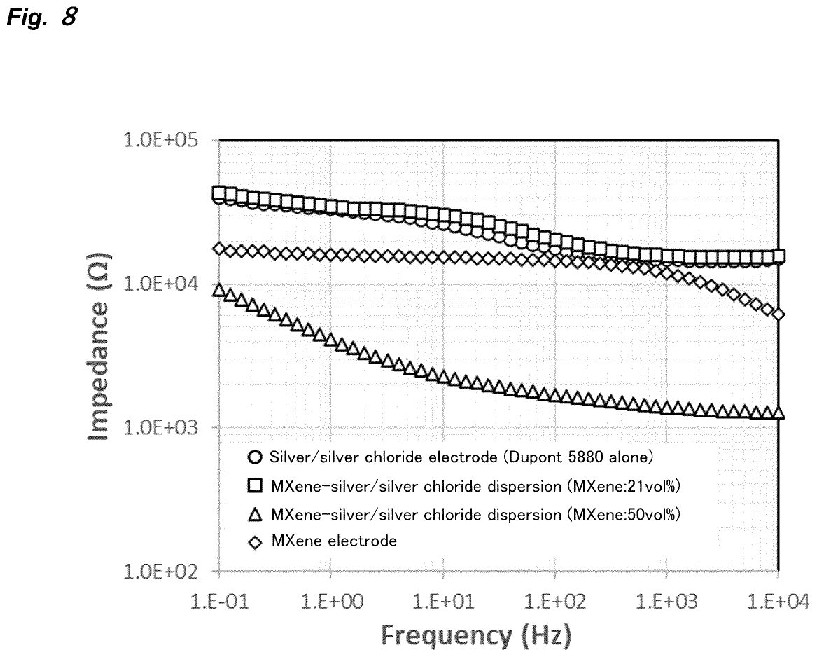

Graphs showing, among the measurement results, the results of Comparative Example 3 (a silver/silver chloride-MXene dispersion film having a volume ratio of MXene of 21% by volume (indicated as “MXene-silver/silver chloride dispersion” in FIG. 8)), Example 4 (a silver/silver chloride-MXene dispersion film having a volume ratio of MXene of 50% by volume (indicated as “MXene-silver/silver chloride dispersion” in FIG. 8)), Comparative Example 5 (a simple electrode of silver/silver chloride), and Comparative Example 6 (an MXene film simple electrode) are shown in FIG. 8. From FIG. 8, even when a film in which silver/silver chloride and MXene were dispersed was formed as in the electrode of the present embodiment, decrease in impedance was observed. In particular, in Examples 3 to 5, in which the volume ratio of MXene was preferably in the range of 25 to 75% by volume, a sufficient decrease in impedance was observed. The reason for this is considered to be that, as described above, the low conductivity of MXene is improved by silver contained in silver/silver chloride.

The electrode of the present disclosure can be utilized for any suitable applications, and can be used preferably as, for example, a biosignal sensing electrode.

### REFERENCE SIGNS LIST

1a, 1b Layer body (MₘXₙ layer)
3a, 5a, 3b, 5b Modifier or terminal T
7a, 7b MXene layer
10a, 10b MXene particle (particle of two-dimensional material)
20a, 20b, 20c, 30, 40 Electrode
21, 41 Electrode substrate
23 Silver/silver chloride electrode section
25 MXene-containing film
27 Tip region of contact pin
31 Support
33 Contact pin
43 Silver/silver chloride-MXene dispersion film

1. An electrode comprising:
a substrate;
a silver/silver chloride electrode section on at least a part of a surface of the substrate; and
a film containing particles of a two-dimensional material including one layer or a plurality of layers on at least a part of a surface of the silver/silver chloride electrode section exposed to an external environment, wherein the one layer or the plurality of layers include a layer body represented by:
MₘXₙ,
wherein M is one or more metals of Group 3, 4, 5, 6, and 7 and includes Ti,
X is a carbon atom, a nitrogen atom, or a combination thereof,
n is not less than 1 and not more than 4, and
m is more than n but not more than 5; and
a modifier or terminal T is present on a surface of the layer body, wherein T is one or more selected from the group consisting of a hydroxy group, a fluorine atom, a chlorine atom, an oxygen atom, and a hydrogen atom.

2. The electrode according to claim 1, wherein the film containing the particles of the two-dimensional material has a thickness of not less than 1 nm and not more than 5 μm.

3. The electrode according to claim 1, wherein the substrate has a tip portion and a longitudinal direction, the silver/silver chloride electrode section is on a surface including the tip portion of the substrate, and the film containing the particles of the two-dimensional material is on an entirety of the surface of the silver/silver chloride electrode section that is exposed to the external environment.

4. The electrode according to claim 1, wherein the electrode has a brush shape comprising a support and a plurality of contact pins constructed to be brought into contact with an object to be measured, wherein
at least one contact pin of the plurality of contact pins has the substrate, the silver/silver chloride electrode section, and the film containing the particles of the two-dimensional material.

5. The electrode according to claim 4, wherein the at least one contact pin has a tip portion, and the silver/silver chloride electrode section is on the tip portion.

6. The electrode according to claim 1, wherein the film containing the particles of the two-dimensional material comprises a polymer.

7. The electrode according to claim 6, wherein the polymer is a water-soluble polymer.

8. The electrode according to claim 7, wherein the water-soluble polymer is one or more selected from the group consisting of poly(3,4-ethylenedioxythiophene)-poly(styrenesulfonic acid) (PEDOT:PSS), Lipidure (registered trademark) A, Lipidure (registered trademark) PMB, polyurethane, polyacrylic acid, sodium polyacrylate, and cationically modified PVA.

9. The electrode according to claim 6, wherein a proportion of the particles of the two-dimensional material in the film is not less than 0.5% by mass and not more than 50% by mass.

10. The electrode according to claim 1, wherein the film containing the particles of the two-dimensional material and the silver/silver chloride electrode section are integrated in a silver/silver chloride dispersion film.

11. The electrode according to claim 10, wherein a volume ratio of the particles of the two-dimensional material in the silver/silver chloride dispersion film is not less than 25% by volume and not more than 75% by volume.

12. The electrode according to claim 4, wherein the film containing the particles of the two-dimensional material and the silver/silver chloride electrode section are integrated in a silver/silver chloride dispersion film.

13. The electrode according to claim 12, wherein a volume ratio of the particles of the two-dimensional material in the silver/silver chloride dispersion film is not less than 25% by volume and not more than 75% by volume.

14. The electrode according to claim 1, wherein the electrode is a biosignal sensing electrode.

15. An electrode comprising:
a substrate;
a silver/silver chloride electrode section; and
a film containing particles of a two-dimensional material including one layer or a plurality of layers, wherein the one layer or the plurality of layers include a layer body represented by:
MₘXₙ,
wherein M is one or more metals of Group 3, 4, 5, 6, and 7 and includes Ti,
X is a carbon atom, a nitrogen atom, or a combination thereof,
n is not less than 1 and not more than 4, and
m is more than n but not more than 5; and
a modifier or terminal T is present on a surface of the layer body, wherein T is one or more selected from the group consisting of a hydroxy group, a fluorine atom, a chlorine atom, an oxygen atom, and a hydrogen atom,
wherein the substrate has a tip portion and a longitudinal direction, the silver/silver chloride electrode section is on a surface including the tip portion of the substrate, and the film containing the particles of the two-dimensional material is on an entirety of the surface of the silver/silver chloride electrode section that is exposed to the external environment.

16. An electrode comprising:
a substrate;
a silver/silver chloride electrode section; and
a film containing particles of a two-dimensional material including one layer or a plurality of layers, wherein the one layer or the plurality of layers include a layer body represented by:
MₘXₙ,
wherein M is one or more metals of Group 3, 4, 5, 6, and 7 and includes Ti,
X is a carbon atom, a nitrogen atom, or a combination thereof,
n is not less than 1 and not more than 4, and
m is more than n but not more than 5; and
a modifier or terminal T is present on a surface of the layer body, wherein T is one or more selected from the group consisting of a hydroxy group, a fluorine atom, a chlorine atom, an oxygen atom, and a hydrogen atom,
wherein the electrode has a brush shape comprising a support and a plurality of contact pins constructed to be brought into contact with an object to be measured, wherein
at least one contact pin of the plurality of contact pins has the substrate, the silver/silver chloride electrode section, and the film containing the particles of the two-dimensional material.

17. An electrode comprising:
a substrate;
a silver/silver chloride electrode section; and
a film containing particles of a two-dimensional material including one layer or a plurality of layers, wherein the one layer or the plurality of layers include a layer body represented by:
MₘXₙ,
wherein M is one or more metals of Group 3, 4, 5, 6, and 7 and includes Ti,
X is a carbon atom, a nitrogen atom, or a combination thereof,
n is not less than 1 and not more than 4, and
m is more than n but not more than 5; and
a modifier or terminal T is present on a surface of the layer body, wherein T is one or more selected from the group consisting of a hydroxy group, a fluorine atom, a chlorine atom, an oxygen atom, and a hydrogen atom,
wherein the film containing the particles of the two-dimensional material further contains silver/silver chloride, and is also a or another silver/silver chloride electrode section.

18. The electrode according to claim 17, wherein a volume ratio of the particles of the two-dimensional material in the film containing the particles of the two-dimensional material is not less than 25% by volume and not more than 75% by volume.
